(19) United States
(12) Patent Application Publication
(10) Pub. No.: US 2025/0172117 A1
(43) Pub. Date: May 29, 2025

(54) PORTABLE HYDRO-GENERATOR

(71) Applicant: Chin Pang Richard Mui, Singapore (SG)

(72) Inventor: Chin Pang Richard Mui, Singapore (SG)

(21) Appl. No.: 18/834,181

(22) PCT Filed: Feb. 7, 2023
(86) PCT No.: PCT/SG2023/050064

§ 371 Date: Jul. 29, 2024

(30) Foreign Application Priority Data
Feb. 11, 2022 (SG) 10202201329R

(51) Int. Cl. F03B 7/00

(52) U.S. Cl. CPC F03B 7/006; F05B 2220/706

(57) ABSTRACT

A portable hydro-generator for generating electrical energy may include a housing including a storage portion configured to store fluid; a first fluid tank attached to the housing and configured to store fluid; a fluid conduit arranged on the storage portion; a rotating element arranged within the housing; a pedal chain arranged through the storage portion and partially around the rotating element within the housing; and a power generator attached to the rotating element. In use, the fluid conduit may be engaged with a fluid pump to extract fluid from the storage portion to create a vacuum space within the storage portion. Upon creation of the vacuum space within the storage portion, the fluid within the first fluid tank may urge the pedal chain to rotate the rotating element to produce rotational energy. The power generator may convert the rotational energy to electrical energy.

### FIELD

The present invention relates to a portable hydro-generator for generating electrical energy.

### BACKGROUND

There have been various attempts to generate power of electricity. These attempts can be broadly categorized as the use of depletable resources and the use of renewable energy.

Current depletable resources include coal, oil and nuclear energy. These resources are known to be pollutive not only upon extraction, but also when these resources are being used. Further, these resources are not freely available in all parts of the world, and regions which possess these resources may tend to hold the rest of the world “at ransom”. In addition, the negative side effects of the use of nuclear energy may be long term. Notwithstanding the negative impacts of these depletable resources, they are currently still being minded, as they are the traditional energy resources. Thus, the supply of these resources is being threatened.

A solution is to engage and harness known renewable energies, for example, solar energy, wind energy and hydraulic energy. Many systems operating with renewable energies rely solely on the presence of these renewable energies. However, the presence of these energies is seasonal and unpredictable, and the energies may not be always found where they are needed. For example, when hydraulics are used as a power generating source, the power generation machines usually have to be built at or around moving water, for example, rivers or near dams. This may not always be economically feasible, and may require rather long term payback.

### SUMMARY

According to a first aspect of the present invention, there may be provided a portable hydro-generator for generating electrical energy. The portable hydro-generator may include a housing including a storage portion configured to store fluid, a first fluid tank attached to the housing and configured to store fluid, a fluid conduit arranged on the storage portion, a rotating element arranged within the housing, a pedal chain arranged through the storage portion and partially around the rotating element within the housing, and a power generator attached to the rotating element. The fluid conduit may be engageable with a fluid pump to extract the fluid from the storage portion to create a vacuum space within the storage portion, and the first fluid tank may be arranged relative to the pedal chain such that upon creation of the vacuum space within the storage portion, the fluid within the first fluid tank may urge the pedal chain to rotate the rotating element to produce rotational energy. The power generator may be configured to convert the rotational energy to electrical energy.

According to a second aspect of the present invention, there may be provided a method for generating electrical energy using a portable hydro-generator. The method may include injecting fluid into a first fluid tank and a housing of the portable hydro-generator, where the first fluid tank may be attached to the housing and the housing may include a storage portion, and where the first fluid tank and the storage portion may be configured to store the fluid; engaging a fluid conduit arranged on the storage portion with a fluid pump; extracting the fluid from the storage portion through the fluid conduit using the fluid pump to create a vacuum space within the storage portion, where the first fluid tank may be arranged relative to a pedal chain through the storage portion and partially around a rotating element within the housing, such that upon creation of the vacuum space within the storage portion, the fluid within the first fluid tank may urge the pedal chain to rotate the rotating element to produce rotational energy; and converting the rotational energy to electrical energy with a power generator attached to the rotating element.

### BRIEF DESCRIPTION OF THE DRAWINGS

The invention will now be described, by way of example only, and with reference to the accompanying drawings in which:

FIG. 1 shows a front view of a portable hydro-generator for generating electrical energy according to an example of the present invention;

FIG. 2 shows a pedal unit of a pedal chain of the portable hydro-generator of FIG. 1;

FIG. 3 shows the portable hydro-generator of FIG. 1 in use according to an example of the present invention; and

FIG. 4 shows a flow diagram of a method for generating electrical energy using the portable hydro-generator of FIG. 1 according to an example of the present invention.

### DETAILED DESCRIPTION

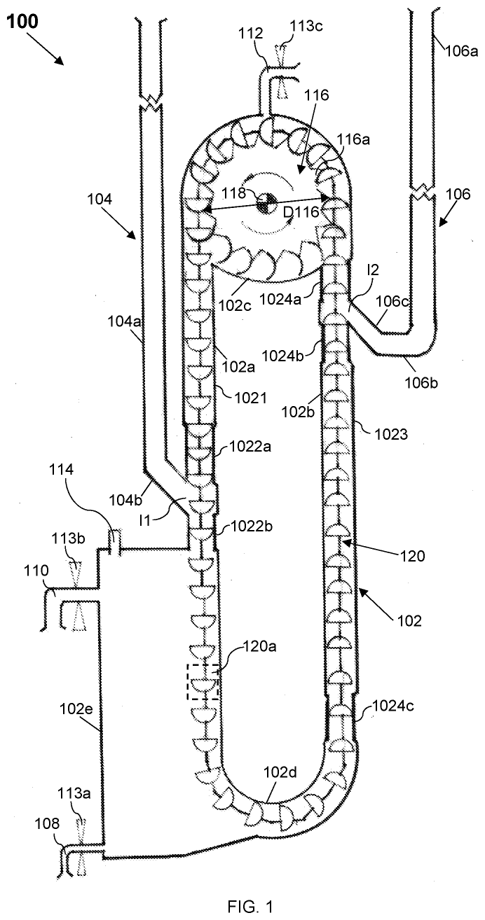

FIG. 1 shows a front view of a portable hydro-generator 100 for generating electrical energy according to an example of the present invention.

The portable hydro-generator 100 may include a housing 102 having a first tubular portion 102a and a second tubular portion 102b, where the first tubular portion 102a and the second tubular portion 102b may be substantially vertical. Further, the second tubular portion 102b may be substantially parallel to the first tubular portion 102a. The housing 102 may further include an intermediate portion 102c and an adjoining portion 102d between the first and second tubular portions 102a, 102b. The adjoining portion 102d may be curved, whereas the intermediate portion 102c may be circular in shape and may be above the adjoining portion 102d. The housing 102 may also include a storage portion 102e configured to store fluid, and the first tubular portion 102a may extend into the storage portion 102e.

The first tubular portion 102a may include at least one regular segment (for example, regular segment 1021) and at least one flow regulator segment (for example flow regulator segments 1022a, 1022b). Similarly, the second tubular portion 102b may include at least one regular segment (for example, regular segment 1023) and at least one flow regulator segment (for example, flow regulator segments 1024a, 1024b, 1024c). Each of the first tubular portion 102a and the second tubular portion 102b may have a smooth bore internal surface. Further, for both the first and second tubular portions 102a, 102b, a cross-sectional area of each of the at least one regular segment 1021, 1023 may be larger than a cross-sectional area of each of the at least one flow regulator segment 1022a, 1022b, 1024a, 1024b, 1024c. In other words, the flow regulator segments 1022a, 1022b, 1024a, 1024b, 1024c may be constrictor sections. Each tubular portion 102a, 102b may be formed by clam shell casting or may be in the form of a seamless cylinder where the entire internal surface of the cylinder may be smooth.

The portable hydro-generator 100 may further include a first fluid tank 104 and a second fluid tank 106. The first fluid tank 104 and the second fluid tank 106 may be attached to the housing 102 and may be configured to store fluid. In some examples, the first fluid tank 104 may be referred to as an inlet tower tank and the second fluid tank 106 may be referred to as an upthrust tower tank.

As shown in FIG. 1, the first fluid tank 104 may have a tubular structure. The first fluid tank 104 may include a substantially vertical segment 104a and a slanted segment 104b, where the slanted segment 104b may be attached to the housing 102, in particular, the first tubular portion 102a of the housing 102. The housing 102 may include a first adjoining section 11 for allowing fluid to enter the housing 102 from the first fluid tank 104. Referring to FIG. 1, the first adjoining section 11 may be arranged between two flow regulator segments 1022a, 1022b of the first tubular portion 102a along a length of the first tubular portion 102a. The slanted segment 104b of the first fluid tank 104 may slant downwards towards the housing 102 to allow fluid within the first fluid tank 104 to flow towards the housing 102 under the force of gravity.

As shown in FIG. 1, the second fluid tank 106 may also have a tubular structure. The second fluid tank 106 may include a substantially vertical segment 106a and a slanted segment 106c attached to the housing 102, in particular, the second tubular portion 102b of the housing 102. The second fluid tank 106 may further include a substantially horizontal segment 106b between the substantially vertical segment 106a and the slanted segment 106c. The housing 102 may include a second adjoining section 12 for allowing fluid to enter the housing 102 from the second fluid tank 106. Referring to FIG. 1, the second adjoining section 12 may be arranged between two flow regulator segments 1024a, 1024b; whereas, the flow regulator segment 1024c may be arranged between the second tubular portion 102b and the adjoining portion 102d of the housing 102. The slanted segment 106c of the second fluid tank 106 may slant upwards towards the housing 102, such that the second adjoining section 12 is above the substantially horizontal segment 106b. This may allow fluid within the second fluid tank 106 to enter the housing 102 under the force of buoyancy.

As shown in FIG. 1, the portable hydro-generator 100 may further include a first fluid conduit 108 arranged on the storage portion 102e of the housing 102. The first fluid conduit 108 may be arranged near the bottom of the storage portion 102e. The first fluid conduit 108 may be engageable with a fluid pump (not shown in FIG. 1) to extract fluid from the storage portion 102e to create a vacuum space within the storage portion 102e or to inject fluid into the storage portion 102e to remove at least a part of the vacuum space. A first valve 113a may be arranged with the first fluid conduit 108 to regulate the extraction or injection of the fluid from or into the storage portion 102e. For example, the first valve 113a may be a check valve, in other words, a non-return valve and may be opened slowly to regulate the extraction or injection of the fluid from or into the storage portion 102e of the housing 102.

The portable hydro-generator 100 may also include a second fluid conduit 110 arranged on the storage portion 102e of the housing 102. The second fluid conduit 110 may be engageable with a fluid pump (not shown in FIG. 1) to extract fluid from the storage portion 102e to create a vacuum space within the storage portion 102e or to inject fluid into the storage portion 102e to remove at least a part of the vacuum space. A second valve 113b may be arranged with the second fluid conduit 110 to regulate the extraction or injection of the fluid from or into the storage portion 102e of the housing 102. For example, the second valve 113b may be a check valve, in other words, a non-return valve and may be opened slowly to regulate the extraction or injection of the fluid from or into the storage portion 102e.

As shown in FIG. 1, the first fluid conduit 108 and the second fluid conduit 110 may be arranged along a same side of the storage portion 102e, and may each include a tube having an opening facing downwards. For example, referring to FIG. 1, the first fluid conduit 108 and the second fluid conduit 110 may each include a tube with a substantially horizontal segment and a substantially vertical segment connected to each other by a curved segment therebetween, such that the opening to the first fluid conduit 108 or the second fluid conduit 110 faces downwards. However, the first fluid conduit 108 and the second fluid conduit 110 may have structures different from that shown in FIG. 1. Further, a cross-sectional area of the second fluid conduit 110 may be larger than a cross-sectional area of the first fluid conduit 108. However, in some alternative examples, a cross-sectional area of the second fluid conduit 110 may be the same or smaller than a cross-sectional area of the first fluid conduit 108.

Referring to FIG. 1, the portable hydro-generator 100 may also include a third fluid conduit 112 arranged on the intermediate portion 102c of the housing 102. The third fluid conduit 112 may be engageable with a fluid pump (not shown in FIG. 1) to inject fluid into or extract fluid from the housing 102. The third fluid conduit 112 may include a tube having a substantially vertical segment and a substantially horizontal segment connected to each other by a curved segment therebetween, such that the opening to the third fluid conduit 112 faces sideways. However, the third fluid conduit 112 may have a different structure from that shown in FIG. 1. A third valve 113c may be arranged with the third fluid conduit 112 to regulate the injection or extraction of the fluid into or from the housing 102 through the third fluid conduit 112. For example, the third valve 113c may be a check valve, in other words, a non-return valve and may be opened slowly to regulate the injection or extraction of the fluid into or from the housing 102 through the third fluid conduit 112.

As described above, each of the first, second and third fluid conduits 108, 110, 112 may be used as a fluid inlet or a fluid outlet. The portable hydro-generator 100 may further include a pump connector 114 arranged on the storage portion 102e of the housing 102 and engageable with a vacuum pump (not shown in FIG. 1) to extract air from the storage portion 102e.

As shown in FIG. 1, the portable hydro-generator 100 may further include a rotating element 116 and a drive shaft 118 arranged within the housing 102, in particular, within the intermediate portion 102c of the housing 102. The rotating element 116 may be rotatable around the drive shaft 118. Further, the rotating element 116 may include a plurality of engaging elements 116a. For example, as shown in FIG. 1, the rotating element 116 may be a sprocket gear with engaging elements 116a in the form of teeth. The diameter D116 of the rotating element 116 may affect the electrical power output of the portable hydro-generator 100. In some examples, the diameter D116 of the rotating element 116 may be about 2 m but this may vary according to the required output. A power generator (not shown in FIG. 1) may be attached to the rotating element 116 and may be configured to convert rotational energy (produced from rotation of the rotating element 116) to electrical energy.

The portable hydro-generator 100 may also include a pedal chain 120 arranged through the storage portion 102e and partially around the rotating element 116 within the housing 102. In particular, referring to FIG. 1, the pedal chain 120 may be arranged along the first tubular portion 102a and the second tubular portion 102b, through the intermediate portion 102c (over the rotating element 116) and through the adjoining portion 102d. The pedal chain 120 may include a plurality of pedal units 120a linked to one another. As shown in FIG. 1, each pedal unit 120a along the pedal chain 120 around the rotating element 116 may abut a respective engaging element 116a of the rotating element 116. Further, as the pedal chain 120 moves, each pedal unit 120a may abut the first tubular portion 102a and the second tubular portion 102b of the housing 102 at each of the at least one flow regulator segment 1022a, 1022b, 1024a, 1024b, 1024c; whereas, each pedal unit 120a may be spaced apart from the first tubular portion 102a and the second tubular portion 102b at each of the at least one regular segment 1021, 1023.

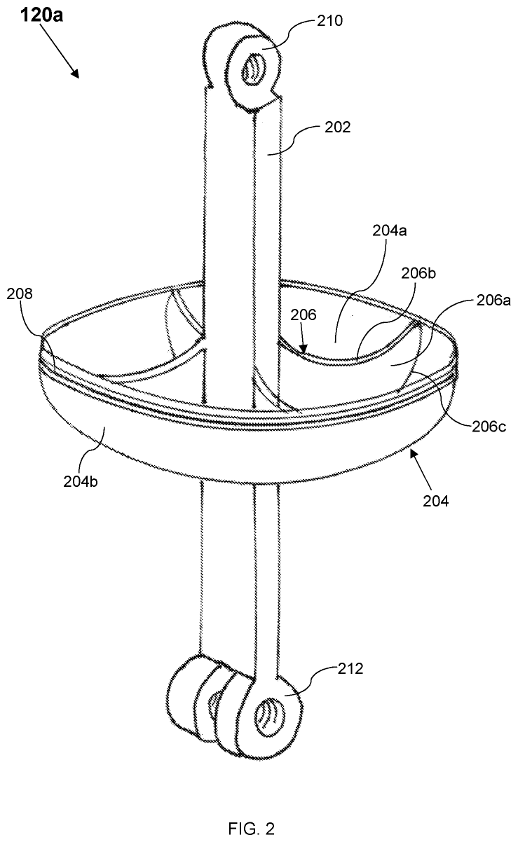

FIG. 2 shows a perspective view of a pedal unit 120a of the pedal chain 120 of the portable hydro-generator 100. The pedal unit 120a may include a link element 202 and a receptacle 204 attached to the link element 202.

As shown in FIG. 2, the receptacle 204 may be bowl-shaped, and may include a curved inner base 204a and a curved outer surface 204b. Both the curved inner base 204a and the curved outer surface 204b may have a smooth finish. A plurality of supporting elements 206 may be arranged within the receptacle 204. The link element 202 may serve as a main connector rod and may extend through the receptacle 204. The supporting elements 206 may attach the receptacle 204 to the link element 202, so that a position of the receptacle 204 along the link element 202 may be maintained. In addition, including the supporting elements 206 within the receptacle 204 may substantially increase the surface area onto which fluid may impinge, and this may in turn increase the force exerted onto the receptacle 204 (hence, the pedal unit 120a) by the fluid.

As shown in FIG. 2, each supporting element 206 may include a substantially flat plate with its side surfaces (e.g. side surfaces 206a) substantially larger than its top and bottom surfaces (e.g. top and bottom surfaces 206b, 206c). Each supporting element 206 may be connected to the link element 202 and its bottom surface 206c may extend along the curved inner base 204a of the receptacle 204. The top surface 206a of each supporting element 206 may be convex towards the curved inner base 204a of the receptacle 204 and the supporting elements 206 may be evenly spaced within the receptacle 204. In one example, the supporting elements 206 may be referred to as ribs. In some examples, the receptacle 204 and the supporting elements 206 may have a different structure from that shown in FIG. 2. For example, the opening at a top of the receptacle 204 may be in the shape of a circle, an oval, a rectangle or any other shape. In some examples, there may be more or less supporting elements 206 than that shown in FIG. 2.

Each pedal unit 120a may include a sealing element 208 that may be configured to abut the first tubular portion 102a and the second tubular portion 102b at each of the at least one flow regulator segment 1022a, 1022b, 1024a, 1024b, 1024c. This may form a seal between the pedal unit 120a and the tubular portion 102a, 102b where flow of fluid across the seal may be restricted. For example, referring to FIG. 2, the sealing element 208 may be provided around the curved outer surface 204b of the receptacle 204. The sealing element 208 may include seal ring slots.

Further, for each pedal unit 120a, the link element 202 may be configured to engage with the link element 202 of another pedal unit 120a. For example, referring to FIG. 2, a first joint 210 may be arranged at a first end of the link element 202 and a second joint 212 may be arranged at a second end (opposite to the first end) of the link element 202. The first joint 210 of a pedal unit 120a may be engageable with the second joint 212 of another pedal unit 120a, such that the plurality of pedal units 120a can be engaged with one another to form the pedal chain 120. In one example, the joints 210, 212 may be knuckle joints with strong push-pull precision integrity.

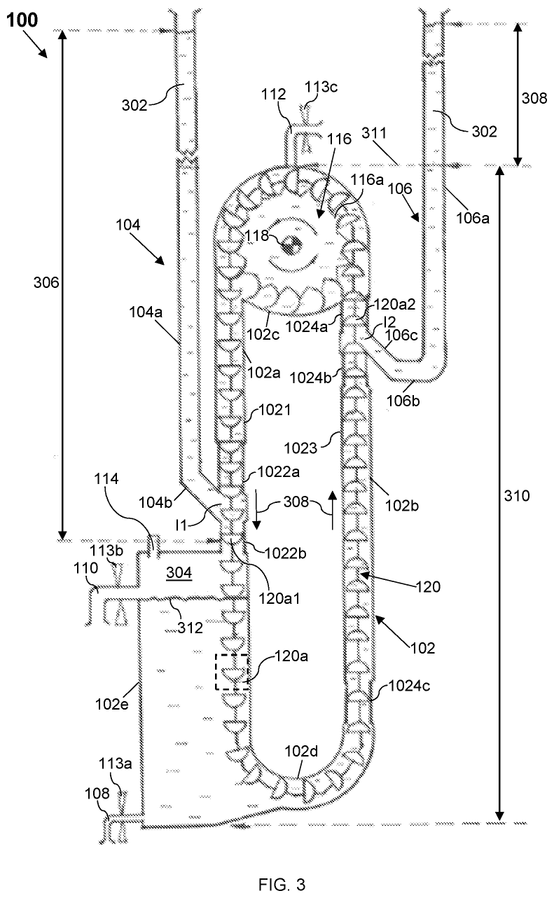

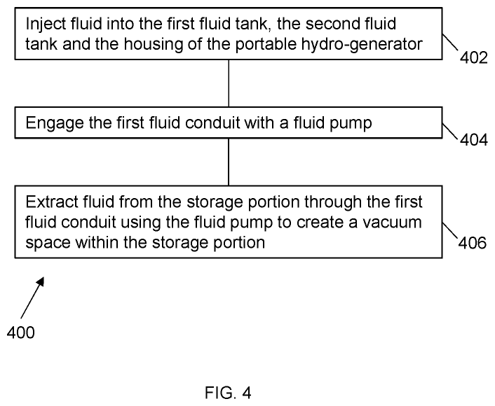

FIG. 3 shows the portable hydro-generator 100 in use according to an example of the present invention. FIG. 4 shows a flow diagram of a method 400 for generating electrical energy using the portable hydro-generator 100 according to an example of the present invention.

Referring to FIG. 4, at 402, fluid 302 (see FIG. 3) may be injected into the first fluid tank 104, the second fluid tank 106 and the housing 102 of the portable hydro-generator 100. This may be performed with the first and second valves 113a, 113b closed and the third valve 113c open. The fluid 302 may be injected through the opening of the first fluid tank 104 and further through the opening of the second fluid tank 106. The fluid 302 may include any type of liquid, such as clean water or seawater without sediments. In some examples, the fluid 302 may further include an antifreeze mixture. The first and second fluid tanks 104, 106 may be filled to the brim with the fluid 302, in other words, the portable hydro-generator 100 may be primed full. Each pedal unit 120a of the pedal chain 120 may be arranged within the housing 102 such that the receptacle 204 of the pedal unit 120a may be filled with the fluid 302. In some examples, the pressure exerted by the fluid 302 (effective hydrostatic pressure) along the depth 306 of the first fluid tank 104 may be about 300 Pa. The pressure exerted by the fluid 302 (upthrust effective pressure) along the depth 308 of the second fluid tank 106 may be about the same as the effective hydrostatic pressure, in other words, may also be about 300 Pa. In some examples, the hydro-generator 100 may operate only when a depth of the fluid 302 within the second fluid tank 106 is above a minimum depth 310. For instance, the housing 102 and the second fluid tank 106 may be filled with fluid 302 until a depth of the fluid 302 in both the housing 102 and the second fluid tank 106 reaches the minimum depth 310 (as indicated by the arrow 311 in FIG. 3). At this point, the first fluid tank 104 may be almost empty due to the presence of the flow regulator segments 1022a, 1022b. Thereafter, the first and second fluid tanks 104, 106 may be further filled with fluid 302, so that the operation of the hydro-generator 100 may start upon creation of a vacuum space as will be elaborated below. In other words, the hydro-generator 100 may be ready for further filling to start operating the hydro-generator 100 when the fluid 302 within the second fluid tank 106 is filled to the minimum depth 310.

Referring to FIG. 4, at 404, the first fluid conduit 108 may be engaged with a fluid pump (not shown in FIG. 3) and at 406, the fluid 302 may be extracted from the storage portion 102e through the first fluid conduit 108 using the fluid pump. This may create a vacuum space 304 (see FIG. 3) within the storage portion 102e. The fluid 302 may be extracted from the storage portion 102e while the first valve 113a is opened slowly. This may help regulate the extraction of the fluid 302 from the storage portion 102e.

In one example, the fluid pump may be a submersible pump. In some examples, the fluid pump may instead be engaged with the second fluid conduit 110 and the fluid 302 may be extracted from the storage portion 102e through the second fluid conduit 110 while the second valve 113b is opened slowly.

Air trapped within the fluid 302 may ascend to a top of the housing 102 near the third fluid conduit 112 and may exit the housing 102 through the third fluid conduit 112. The air trapped within the fluid 302 may also ascend into the vacuum space 304 and in one example, the second valve 113b may be opened after creating the vacuum space 304, so that air may exit the storage portion 102e through the second fluid conduit 110. In some examples, the rotating element 116 may be rotated to urge air out of the housing 102 through one or both of the fluid conduits 110, 112. The rotating element 116 may be rotated by for example, activating the motor of the power generator attached to the rotating element 116.

As shown in FIG. 3, the vacuum space 304 may extend from the top of the storage portion 102e until the bottom of the second fluid conduit 110, and the level 312 of the fluid in the storage portion 102e may be referred to as a perceived water level in one example. In some examples, after extracting the fluid 302 from the storage portion 102e, the perceived water level 312 may be adjusted by injecting and/or extracting the fluid 302 into and/or out of the storage portion 102e through one or both of the first and second fluid conduits 108, 110 until the desired perceived water level 312 is achieved. After the vacuum space 304 is created, the first and/or second valves 113a, 113b may be closed. In some examples, a vacuum pump may be further connected to the pump connector 114 to extract air from the storage portion 102e, where this extraction of air from the storage portion 102e may be performed after or simultaneously with the extraction of the fluid 302 from the storage portion 102e.

Referring to FIG. 3, the first fluid tank 104 may be arranged relative to the pedal chain 120 such that upon creation of the vacuum space 304 within the storage portion 102e, the fluid 302 within the first fluid tank 104 may urge the pedal chain 120 to rotate the rotating element 116 to produce rotational energy. For example, the fluid 302 within the first fluid tank 104 may exert a downward pressure on the pedal unit 120a1 (see FIG. 3) immediately above the vacuum space 304 under the force of gravity. The pedal unit 120a1 may hence be pushed downwards. In turn, the pedal chain 120 moves (e.g. in the direction 308 as shown in FIG. 3) and the pedal units 120a abutting the respective engaging elements 116a of the rotating element 116 may urge the engaging elements 116a, causing the rotating element 116 to rotate. Therefore, urging of the pedal chain 120 by the fluid 302 within the first fluid tank 104 may rotate the rotating element 116. The flow regulator segment 1022b may serve as the discharge action point of the fluid 302 from the first fluid tank 104 into the vacuum space 304; whereas, the flow regulator segment 1024c may serve as the ingestion action point of the fluid 302 from the storage portion 102e. The vacuum space 304 may be automatically maintained throughout the operation of the portable hydro-generator 100. In other words, the vacuum space 304 may be maintained without further injection or removal of the fluid 302 into or out of the housing 102 after the pedal chain 120 begins to move.

The second fluid tank 106 may be arranged relative to the pedal chain 120 such that the fluid 302 within the second fluid tank 106 may urge the pedal chain 120 to rotate the rotating element 116. For example, due to the upward slant of the slanted segment 106c of the second fluid tank 106, the fluid 302 within the second fluid tank 106 may exert an upward pressure on the pedal unit 120a2 (see FIG. 3) immediately above the second adjoining section 12 under the force of buoyancy. This may further urge the pedal chain 120 (e.g. in the direction 308 in FIG. 3) around the rotating element 116, hence further rotating the rotating element 116.

In other words, the driving forces of the portable hydro-generator 100 may include gravity and buoyancy. The gravity may contribute to the downward pressure on the pedal unit 120a1 and hence, the driving force on the rotating element 116 at the side nearer to the first fluid tank 104. The buoyancy may contribute to the upward pressure on the pedal unit 120a2 and hence, the driving force on the rotating element 116 at the side nearer to the second fluid tank 106. The rotational energy generated by the rotation of the rotating element 116 may then be converted into electrical energy by the power generator (not shown in the figures). Adjustments to pressure input along the depths 306, 308 and adjustments to the perceived water level 312 may affect the performance of the hydro-generator 100. These adjustments may be performed independently, and two or more of these adjustments may be performed in combination to achieve the desired performance of the hydro-generator 100.

To halt the operation of the portable hydro-generator 100, one or more fluid pumps may be attached to one or more of the first, second and third fluid conduits 108, 110, 112. One or more of the first, second and third valves 113a, 113b, 113c may be opened and the fluid pump(s) may be used to inject fluid into the storage portion 102e of the housing 102, so as to fill up the vacuum space 304.

During the operation of the portable hydro-generator 100, the flow regulator segments 1022a, 1022b, 1024a, 1024b, 1024c may separate the volume of the tubular portions 102a, 102b of the housing 102 equally timewise along the flow path of the fluid 302 through these tubular portions 102a, 102b. The sealing element 208 around the receptacle 204 of each pedal unit 120a may form a seal with the flow regulator segments 1022a, 1022b, 1024a, 1024b, 1024c to reduce pressed or forced through leakages between the different volumes of the tubular portions 102a, 102b. This can achieve a more consistent and smoother operation of the portable hydro-generator 100. For example, the seal of the pedal unit 120a with the flow regulator segment 1022a and the seal of the pedal unit 120a with the flow regulator segment 1022b may help to achieve a better separation between the storage portion 102e and the first tubular portion 102a (aft and fore chambers). In addition, the flow regulator segment 1024c may be positioned substantially below the perceived water level 312, so as to maintain a consistent ingestion of fast flowing fluid back to the top of the portable hydro-generator 100 to continue the rotation of the pedal chain 120 around the rotating element 116. The amount of fluid ingestion through the flow regulator segment 1024c may be equal to the amount of fluid discharge through the flow regulator segment 1022b.

In one example, various segments of the housing 102 (e.g. the flow regulator segments 1022a, 1022b, 1024a, 1024b, 1024c and the regular segments 1021, 1023 of the tubular portions 102a, 102b, the intermediate portion 102c, the adjoining portion 102d and the storage portion 102e) may be formed separately by for example, clam shell casting. These segments of the housing 102 may then be assembled with one another, and with the remaining parts of the portable hydro-generator 100. In some examples, the first fluid tank 104 and the second fluid tank 106 may be detachably connected to the housing 102 to provide ease of portability and deployment of the portable hydro-generator 100. For example, the fluid tanks 104, 106 may snap fit into the adjoining sections 11, 12 of the housing 102. However, the fluid tanks 104, 106 may alternatively be secured by a non-detachable element to the housing 102.

In some examples, the portable hydro-generator 100 may further include a pressure-adjusting element (not shown in FIG. 1) configured to adjust the pressure on the fluid in one or both of the first fluid tank 104 and the second fluid tank 106. For example, the pressure-adjusting element may include a detachable cover over one of or each of the fluid tanks 104, 106. With the cover over the fluid tank 104, 106, the fluid tank 104, 106 may become a pressure vessel (where the fluid within the tank 104, 106 may be held at a pressure higher than the ambient pressure). Increasing the pressure on the fluid in the first fluid tank 104 may in turn increase the pressure on the pedal unit 120a1; whereas, increasing the pressure on the fluid in the second fluid tank 106 may in turn increase the pressure on the pedal unit 120a2. This may help to increase the speed of rotation of the pedal chain 120, hence increasing the throughput of the portable hydro-generator 100. In some examples, the detachable cover may further include a pressure regulating mechanism for adjusting the pressure on the fluid in the fluid tank 104, 106.

In some examples, the second fluid tank 106 may be omitted and the portable hydro-generator 100 may be driven mainly by gravity (that contributes to the driving force on the rotating element 116 at the side nearer to the first fluid tank 104). In some examples, the movement sequence of the pedal chain 120 may be adjusted by moving the rotating element 116 to a higher position.

In some examples, there may be more than one inlet tower tank similar to the first fluid tank 104 and arranged alongside the first fluid tank 104, wherein the additional inlet tower tank(s) may also be attached to the housing 102 at the first adjoining section 11, or may be attached to the housing 102 at separate respective adjoining sections. In some examples, there may be more than one upthrust tower similar to the second fluid tank 106 and arranged alongside the second fluid tank 106, wherein the additional upthrust tower tank(s) may be attached to the housing 102 at the second adjoining section 12, or may be attached to the housing 102 at separate respective adjoining sections.

The portable hydro-generator 100 may be used in various types of environments. For example, it may also be used underground or underwater. The portable hydro-generator 100 may be useful for small units in high rise buildings with rooftop water tanks. In these small units, the portable hydro-generator 100 may be installed with the first and second fluid tanks 104, 106 arranged along the tall vertical building walls, and filled with fluid from the rooftop water tanks to drive the rotating element 116. In some examples, the portable hydro-generator 100 may be arranged within a rotating centrifuge, such that gravity is simulated within the centrifuge to drive the rotating element 116. Such an arrangement may allow the portable hydro-generator 100 to operate even in environments without gravity, for example, in space.

In various examples, an apparatus including a plurality of portable hydro-generators 100 may be used for providing electrical energy to multiple devices. The plurality of portable hydro-generators 100 may be arranged side-by-side and may have different sizes. For example, a smaller portable hydro-generator 100 including a shorter pedal chain 120 and a smaller rotating element 116 may be used for devices requiring a lower energy input; whereas, a larger portable hydro-generator 100 including a longer pedal chain 120 and a larger rotating element 116 may be used for devices requiring a higher energy input.

By creating a vacuum space 304 within the storage portion 102e of the housing 102, the portable hydro-generator 100 may be operated using natural forces such as gravity and buoyancy, in particular, weight of fluid on one side of the rotating element 116 and an upthrust based on Archimedes principle on the other side of the rotating element 116. A high directional torque on the pedal unit 120a1 may thus be generated upon creation of the vacuum space 304, causing the rotating element 116 to rotate at a high speed. Hence, the portable hydro-generator 100 may be more efficient as compared to prior art portable hydro-generators. Further, the portable hydro-generator 100 may be a totally carbon-free power delivery system with no carbon combustion and a nett zero carbon emission. Therefore, as compared to internal combustion engines and other fuel-driven engines for generating electrical energy to power current industries, the portable hydro-generator 100 may have a lower negative impact on the environment. In addition, the portable hydro-generator 100 may be used in different types of environment and therefore, may provide a versatile way of generating electricity where it is needed.

Examples of the present disclosure may have the following features. The reference numerals of the elements in the Figures resembling the features stated are provided to indicate that they are examples of such features.

A portable hydro-generator (e.g. 100) for generating electrical energy may include a housing (e.g. 102) including a storage portion (e.g. 102e) configured to store fluid (e.g. 302); a first fluid tank (e.g. 104) attached to the housing (e.g. 102) and configured to store fluid (e.g. 302); a fluid conduit (e.g. 108 or 110) arranged on the storage portion (e.g. 102e); a rotating element (e.g. 116) arranged within the housing (e.g. 102); a pedal chain (e.g. 120) arranged through the storage portion (e.g. 102e) and partially around the rotating element (e.g. 116) within the housing (e.g. 102); and a power generator attached to the rotating element (e.g. 116); wherein the fluid conduit (e.g. 108 or 110) may be engageable with a fluid pump to extract the fluid (e.g. 302) from the storage portion (e.g. 102e) to create a vacuum space (e.g. 304) within the storage portion (e.g. 102e); and wherein the first fluid tank (e.g. 104) may be arranged relative to the pedal chain (e.g. 120) such that upon creation of the vacuum space (e.g. 304) within the storage portion (e.g. 102e), the fluid (e.g. 302) within the first fluid tank (e.g. 104) urges the pedal chain (e.g. 120) to rotate the rotating element (e.g. 116) to produce rotational energy; and wherein the power generator may be configured to convert the rotational energy to electrical energy.

The portable hydro-generator (e.g. 100) may further include a pump connector (e.g. 114) arranged on the storage portion (e.g. 102e) of the housing (e.g. 102) and engageable with a vacuum pump to extract air from the storage portion (e.g. 102e).

The portable hydro-generator (e.g. 100) may further include a valve (e.g. 113a or 113b) arranged with the fluid conduit (e.g. 108 or 110) to regulate the extraction of the fluid (e.g. 302) from the storage portion (e.g. 102e).

The portable hydro-generator (e.g. 100) may further include a further fluid conduit (e.g. 110 or 108) arranged on the storage portion (e.g. 102e), wherein the further fluid conduit (e.g. 110 or 108) may be engageable with the fluid pump to inject fluid into the storage portion (e.g. 102e) to remove the vacuum space (e.g. 304).

The portable hydro-generator (e.g. 100) may further include a further valve (e.g. 113b or 113a) arranged with the further fluid conduit (e.g. 110 or 108) to regulate the injection of the fluid into the storage portion (e.g. 102e).

A cross-sectional area of the further fluid conduit (e.g. 110 or 108) may be larger than a cross-sectional area of the fluid conduit (e.g. 108 or 110).

The first fluid tank (e.g. 104) may include a substantially vertical segment (e.g. 104a) and a slanted segment (e.g. 104b) attached to the housing (e.g. 102), wherein the slanted segment (e.g. 104b) may slant downwards towards the housing (e.g. 102).

The portable hydro-generator (e.g. 100) may further include a second fluid tank (e.g. 106) attached to the housing (e.g. 102) and configured to store fluid (e.g. 302), wherein the second fluid tank (e.g. 106) may be arranged relative to the pedal chain (e.g. 120) such that the fluid (e.g. 302) within the second fluid tank (e.g. 106) urges the pedal chain (e.g. 120) to rotate the rotating element (e.g. 116).

The second fluid tank (e.g. 106) may include a substantially vertical segment (e.g. 106a) and a slanted segment (e.g. 106c) attached to the housing (e.g. 102), wherein the slanted segment (e.g. 106c) may slant upwards towards the housing (e.g. 102).

The second fluid tank (e.g. 106) may further include a substantially horizontal segment (e.g. 106b) between the substantially vertical segment (e.g. 106a) and the slanted segment (e.g. 106c).

The housing (e.g. 102) may include a first tubular portion (e.g. 102a) extending into the storage portion (e.g. 102e) and a second tubular portion (e.g. 102b) substantially parallel to the first tubular portion (e.g. 102a), and wherein the first fluid tank (e.g. 104) may be attached to the first tubular portion (e.g. 102a) and the second fluid tank (e.g. 106) may be attached to the second tubular portion (e.g. 102b).

The first tubular portion (e.g. 102a) and the second tubular portion (e.g. 102b) may be substantially vertical.

The first tubular portion (e.g. 102a) may include at least one regular segment (e.g. 1021) and at least one flow regulator segment (e.g. 1022a, 1022b), wherein a cross-sectional area of each of the at least one regular segment (e.g. 1021) may be larger than a cross-sectional area of each of the at least one flow regulator segment (e.g. 1022a, 1022b).

The housing (e.g. 102) may include a first adjoining section (e.g. 11) for allowing fluid (e.g. 302) to enter the housing (e.g. 102) from the first fluid tank (e.g. 104), and wherein the first adjoining section (e.g. 11) may be arranged between two flow regulator segments (e.g. 1022a, 1022b) of the first tubular portion (e.g. 102a) along a length of the first tubular portion (e.g. 102a).

The second tubular portion (e.g. 102b) may include at least one regular segment (e.g. 1023) and at least one flow regulator segment (e.g. 1024a, 1024b, 1024c), wherein a cross-sectional area of each of the at least one regular segment (e.g. 1023) may be larger than a cross-sectional area of each of the at least one flow regulator segment (e.g. 1024a, 1024b, 1024c).

The housing (e.g. 102) may include a second adjoining section (e.g. 12) for allowing fluid (e.g. 302) to enter the housing (e.g. 102) from the second fluid tank (e.g. 106), and wherein the second adjoining section (e.g. 12) may be arranged between two flow regulator segments (e.g. 1024a, 1024b) of the second tubular portion (e.g. 102b) along a length of the second tubular portion (e.g. 102b).

The pedal chain (e.g. 120) may include a plurality of pedal units (e.g. 120a), wherein each pedal unit (e.g. 120a) may abut the first tubular portion (e.g. 102a) and the second tubular portion (e.g. 102b) at each of the at least one flow regulator segment (e.g. 1022a, 1022b, 1024a, 1024b, 1024c); and may be spaced apart from the first tubular portion (e.g. 102a) and the second tubular portion (e.g. 102b) at each of the at least one regular segment (e.g. 1021, 1023).

Each pedal unit (e.g. 120a) may further include a sealing element (e.g. 208), wherein the sealing element (e.g. 208) may be configured to abut the first tubular portion (e.g. 102a) and the second tubular portion (e.g. 102b) at each of the at least one flow regulator segment (e.g. 1022a, 1022b, 1024a, 1024b, 1024c).

The rotating element (e.g. 116) may include engaging elements (e.g. 116a) and the pedal chain (e.g. 120) may include a plurality of pedal units (e.g. 120a) configured to abut respective ones of the engaging elements (e.g. 116a), such that urging of the pedal chain (e.g. 120) by the fluid (e.g. 302) within the first fluid tank (e.g. 104) rotates the rotating element (e.g. 116).

The pedal chain (e.g. 120) may include a plurality of pedal units (e.g. 120a), wherein each pedal unit (e.g. 120a) may include a link element (e.g. 202) and a receptacle (e.g. 204) attached to the link element (e.g. 202); and wherein for each pedal unit (e.g. 120a), the link element (e.g. 202) may be configured to engage with the link element (e.g. 202) of another pedal unit (e.g. 120a).

Each pedal unit (e.g. 120a) may be arranged within the housing (e.g. 102) such that the receptacle (e.g. 204) of the pedal unit (e.g. 120a) may be filled with the fluid (e.g. 302).

The housing (e.g. 102) may further include an intermediate portion (e.g. 102c) between the first tubular portion (e.g. 102a) and the second tubular portion (e.g. 102b); and the rotating element (e.g. 116) may be arranged within the intermediate portion (e.g. 102c) and the pedal chain (e.g. 120) may be arranged along the first tubular portion (e.g. 102a) and the second tubular portion (e.g. 102b), and through the intermediate portion (e.g. 102c).

The portable hydro-generator (e.g. 100) may further include an additional fluid conduit (e.g. 112) arranged on the intermediate portion (e.g. 102c), wherein the additional fluid conduit (e.g. 112) may be engageable with the fluid pump to inject fluid into the housing (e.g. 102).

The portable hydro-generator (e.g. 100) may further include an additional valve (e.g. 113c) arranged with the additional fluid conduit (e.g. 112) to regulate the injection of the fluid into the housing.

A method for generating electrical energy using a portable hydro-generator (e.g. 100) may include injecting fluid (e.g. 302) into a first fluid tank (e.g. 104) and a housing (e.g. 102) of the portable hydro-generator (e.g. 100), wherein the first fluid tank (e.g. 104) may be attached to the housing (e.g. 102) and the housing (e.g. 102) may include a storage portion (e.g. 102e), and wherein the first fluid tank (e.g. 104) and the storage portion (e.g. 102e) may be configured to store the fluid (e.g. 302); engaging a fluid conduit (e.g. 108 or 110) arranged on the storage portion (e.g. 102e) with a fluid pump; and extracting the fluid (e.g. 302) from the storage portion (e.g. 102e) through the fluid conduit (e.g. 108 or 110) using the fluid pump to create a vacuum space (e.g. 304) within the storage portion (e.g. 102e); wherein the first fluid tank (e.g. 104) may be arranged relative to a pedal chain (e.g. 120) arranged through the storage portion (e.g. 102e) and partially around a rotating element (e.g. 116) within the housing (e.g. 102) such that upon creation of the vacuum space (e.g. 304) within the storage portion (e.g. 102e), the fluid (e.g. 302) within the first fluid tank (e.g. 104) urges the pedal chain (e.g. 120) to rotate the rotating element (e.g. 116) to produce rotational energy; and converting the rotational energy to electrical energy with a power generator attached to the rotating element (e.g. 116).

In the specification and claims, unless the context clearly indicates otherwise, the term “comprising” has the non-exclusive meaning of the word, in the sense of “including at least” rather than the exclusive meaning in the sense of “consisting only of”. The same applies with corresponding grammatical changes to other forms of the word such as “comprise”, “comprises” and so on.

While the invention has been described in the present disclosure in connection with a number of examples and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A portable hydro-generator for generating electrical energy, the portable hydro-generator comprising:
a housing comprising a storage portion configured to store fluid;
a first fluid tank attached to the housing and configured to store fluid;
a fluid conduit arranged on the storage portion;
a rotating element arranged within the housing;
a pedal chain arranged through the storage portion and partially around the rotating element within the housing; and
a power generator attached to the rotating element;
a second fluid tank attached to the housing and configured to store fluid, wherein the second fluid tank is arranged relative to the pedal chain such that the fluid within the second fluid tank urges the pedal chain to rotate the rotating element, wherein the second fluid tank comprises a substantially vertical segment and a slanted segment attached to the housing, wherein the slanted segment slants upwards towards the housing,
wherein the fluid conduit is engageable with a fluid pump to extract the fluid from the storage portion to create a vacuum space within the storage portion; and wherein the first fluid tank is arranged relative to the pedal chain such that upon creation of the vacuum space within the storage portion, the fluid within the first fluid tank urges the pedal chain to rotate the rotating element to produce rotational energy; and
wherein the power generator is configured to convert the rotational energy to electrical energy.

2. The portable hydro-generator according to claim 1, further comprising a pump connector arranged on the storage portion of the housing and engageable with a vacuum pump to extract air from the storage portion.

3. The portable hydro-generator according to claim 1, further comprising a valve arranged with the fluid conduit to regulate the extraction of the fluid from the storage portion.

4. The portable hydro-generator according to claim 1, further comprising a further fluid conduit arranged on the storage portion, wherein the further fluid conduit is engageable with the fluid pump to inject fluid into the storage portion to remove the vacuum space.

5. The portable hydro-generator according to claim 4, further comprising a further valve arranged with the further fluid conduit to regulate the injection of the fluid into the storage portion.

6. The portable hydro-generator according to claim 4, wherein a cross-sectional area of the further fluid conduit is larger than a cross-sectional area of the fluid conduit.

7. The portable hydro-generator according to claim 1, wherein the first fluid tank comprises a substantially vertical segment and a slanted segment attached to the housing, wherein the slanted segment slants downwards towards the housing.

8. (canceled)

9. (canceled)

10. The portable hydro-generator according to claim 1, wherein the second fluid tank further comprises a substantially horizontal segment between the substantially vertical segment and the slanted segment.

11. The portable hydro-generator according to claim 8, wherein the housing comprises a first tubular portion extending into the storage portion and a second tubular portion substantially parallel to the first tubular portion, and wherein the first fluid tank is attached to the first tubular portion and the second fluid tank is attached to the second tubular portion.

12. The portable hydro-generator according to claim 11, wherein the first tubular portion and the second tubular portion are substantially vertical.

13. The portable hydro-generator according to claim 11, wherein the first tubular portion comprises at least one regular segment and at least one flow regulator segment, wherein a cross-sectional area of each of the at least one regular segment is larger than a cross-sectional area of each of the at least one flow regulator segment.

14. The portable hydro-generator according to claim 13, wherein the housing comprises a first adjoining section for allowing fluid to enter the housing from the first fluid tank, and wherein the first adjoining section is arranged between two flow regulator segments of the first tubular portion along a length of the first tubular portion.

15. The portable hydro-generator according to claim 11, wherein the second tubular portion comprises at least one regular segment and at least one flow regulator segment, wherein a cross-sectional area of each of the at least one regular segment is larger than a cross-sectional area of each of the at least one flow regulator segment.

16. The portable hydro-generator according to claim 15, wherein the housing comprises a second adjoining section for allowing fluid to enter the housing from the second fluid tank, and wherein the second adjoining section is arranged between two flow regulator segments of the second tubular portion along a length of the second tubular portion.

17. The portable hydro-generator according to claim 13, wherein the pedal chain comprises a plurality of pedal units, wherein each pedal unit abuts the first tubular portion and the second tubular portion at each of the at least one flow regulator segment; and is spaced apart from the first tubular portion and the second tubular portion at each of the at least one regular segment.

18. The portable hydro-generator according to claim 17, wherein each pedal unit further comprises a sealing element, wherein the sealing element is configured to abut the first tubular portion and the second tubular portion at each of the at least one flow regulator segment.

19. The portable hydro-generator according to claim 1, wherein the rotating element comprises engaging elements and the pedal chain comprises a plurality of pedal units configured to abut respective ones of the engaging elements, such that urging of the pedal chain by the fluid within the first fluid tank rotates the rotating element.

20. The portable hydro-generator according to claim 1, wherein the pedal chain comprises a plurality of pedal units, wherein each pedal unit comprises a link element and a receptacle attached to the link element; and wherein for each pedal unit, the link element is configured to engage with the link element of another pedal unit.

21. The portable hydro-generator according to claim 20, wherein each pedal unit is arranged within the housing such that the receptacle of the pedal unit is filled with the fluid.

22. The portable hydro-generator according to claim 11, wherein the housing further comprises an intermediate portion between the first tubular portion and the second tubular portion; and
wherein the rotating element is arranged within the intermediate portion and the pedal chain is arranged along the first tubular portion and the second tubular portion, and through the intermediate portion.

23. The portable hydro-generator according to claim 22, further comprising an additional fluid conduit arranged on the intermediate portion, wherein the additional fluid conduit is engageable with the fluid pump to inject fluid into the housing.

24. The portable hydro-generator according to claim 23, further comprising an additional valve arranged with the additional fluid conduit to regulate the injection of the fluid into the housing.

25. A method for generating electrical energy using a portable hydro-generator, the method comprising:
injecting fluid into a first fluid tank and a housing of the portable hydro-generator, wherein the first fluid tank is attached to the housing and the housing comprises a storage portion, and wherein the first fluid tank and the storage portion are configured to store the fluid;
engaging a fluid conduit arranged on the storage portion with a fluid pump;
extracting the fluid from the storage portion through the fluid conduit using the fluid pump to create a vacuum space within the storage portion, wherein the first fluid tank is arranged relative to a pedal chain through the storage portion and partially around a rotating element within the housing, such that upon creation of the vacuum space within the storage portion, the fluid within the first fluid tank urges the pedal chain to rotate the rotating element to produce rotational energy; and
converting the rotational energy to electrical energy with a power generator attached to the rotating element.
